(19) United States
(12) Patent Application Publication
(10) Pub. No.: US 2020/0259814 A1
(43) Pub. Date: Aug. 13, 2020

(54) APPLICATION LOGIN CONTROL METHOD, SERVER TERMINAL, AND COMPUTER-READABLE STORAGE MEDIUM

(71) Applicant: Ping An Technology (Shenzhen) Co., Ltd., Shenzhen, Guangdong (CN)

(72) Inventor: Jun Fu, Shenzhen, Guangdong (CN)

(73) Assignee: Ping An Technology (Shenzhen) Co., Ltd., Shenzhen, Guangdong (CN)

(21) Appl. No.: 16/097,616

(22) PCT Filed: Feb. 10, 2018
(86) PCT No.: PCT/CN2018/076188

§ 371 Date: Oct. 29, 2018

(30) Foreign Application Priority Data
Jun. 25, 2017 (CN) 201710490424.4

(51) Int. Cl. H04L 29/06; H04W 12/06

(52) U.S. Cl. CPC H04L 63/0815; H04L 63/0823; H04L 63/083; H04W 12/06

(57) ABSTRACT

The present disclosure provides an application login control method, including: when a user logs in a portal system and accesses a first application of the portal system, obtaining first authority control information of the user in the first application; when a user switches from the first application to a second application of the portal system, transferring a preset second authentication key between the portal system and the second application to a second application server corresponding to the second application, and receiving an operation authority authentication result of the user in the second application from the second application server obtained according to the second authentication key transferred by the portal system; and If the operation authority authentication of the user in the second application is successful, obtaining second authority control information of the user in the second application, and performing the corresponding operation of the user in the second application.

### CROSS REFERENCE OF RELATED APPLICATIONS

This application claims the benefit of priority from Chinese Patent Application No. 201710490424.4, filed on Jun. 25, 2017 and entitled “Application Login Control Method, Server terminal and Computer-Readable Storage Medium”, the entire content of which is incorporated herein by reference.

### TECHNICAL FIELD

This application relates to the field of computer information technology, and more particularly, to an application login control method, server terminal and computer-readable storage medium.

### BACKGROUND

When there are multiple different applications within a unified portal, single sign on (SSO) is typically required to avoid multiple logins by a user, in which case user information and authority control are consistent in different applications. However, if the user information and authority control of one user are different between different applications, the user still needs to log in different applications several times. Therefore, the current technology is not flexible enough to handle multiple logins between applications with different authorities and needs to be improved.

### SUMMARY OF THE DISCLOSURE

The present disclosure provides a login control method, server terminal and computer-readable storage medium which can realize user shielding by login control among applications of different operation authorities, thus, users does not need to log in multiple times, which is safe and convenient.

A server terminal provided in the present disclosure includes a memory, a processor and an application login control system stored on the memory and running on the processor; the application login control system, when being executed by the processor, performing the following steps:

when a user logs in a portal system and accesses a first application of the portal system, obtaining first authority control information of the user in the first application;

when a user switches from the first application to a second application of the portal system, transferring a preset second authentication key between the portal system and the second application to a second application server corresponding to the second application, and receiving an operation authority authentication result of the user in the second application from the second application server obtained according to the second authentication key transferred by the portal system; and

If the operation authority authentication of the user in the second application is successful, obtaining second authority control information of the user in the second application, and performing the corresponding operation of the user in the second application.

An application login control method provided in the present disclosure can be applied in a server terminal, including:

when a user logs in a portal system and accesses a first application of the portal system, obtaining first authority control information of the user in the first application;

when the user switches from the first application to a second application of the portal system, transferring a preset second authentication key between the portal system and the second application to a second application server corresponding to the second application, and receiving an operation authority authentication result of the user in the second application server from the second application server obtained according to the second authentication key transferred by the portal system;

if the operation authority authentication of the user in the second application is successful, obtaining second authority control information of the user in the second application, and performing the corresponding operation of the user in the second application.

The present disclosure further provides a computer-readable storage medium with an application login control system stored thereon, which, when being executed by one or more processors, is capable of causing the one or more processors to perform the steps of the above application login control method.

In the server terminal, application login control method, and computer-readable storage medium of the present disclosure, different authentication keys are preset between the portal system and different applications; when the user switches from the first application of the portal system to the second application of a different operation authority, the portal system authenticates automatically whether the user has the operation authority in the second application according to the preset authentication key; when the authentication is successful, the portal system obtains the second authority control information of the user in the second application and performs the corresponding operation of the user in the second application. The whole authentication process is completed automatically between the portal system and different applications and user shielding by login control among applications of different authorities can be achieved, thus, the user does not need to log in the portal system multiple times, which is safe and convenient.

### BRIEF DESCRIPTION OF THE DRAWINGS

The present disclosure will be described in more detail with reference to the accompany drawings and the embodiments, wherein in the drawings:

FIG. 1 is a schematic diagram of an optional application environment for each embodiment of the present disclosure;

FIG. 2 is a hardware configuration illustrating a server terminal of FIG. 1 in accordance with an embodiment of the present disclosure;

FIG. 3 is a block functional diagram of an application login control system according to an embodiment of the present disclosure; and

FIG. 4 is a schematic flowchart of an implementation process of an application login control method according to an embodiment of the present disclosure.

### REFERENCE MARK

| | |
|---|---|
| Server terminal | 2 |
| Network | 3 |
| First application sever | 4 |
| Second application sever | 5 |
| Memory | 21 |
| Processor | 22 |
| Network interface | 23 |
| Application login control system | 20 |
| Information acquiring module | 201 |
| Authority authentication module | 202 |
| Execution Module | 203 |
| Steps | S41-S43 |

### Preferred Embodiments

For clearly understanding technical features, purpose, and effect of the present disclosure, embodiments are given in detail hereinafter with reference to the accompanying drawings. It should be understood that the specific embodiments here are used only to interpret this application and not limit to this application. All other implementation of the case obtained by one having ordinary skill in the art without creative work should be considered within the scope of this application for protection.

In addition, the descriptions, such as the “first”, the “second” in the present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

As used herein, the terms “including”, “comprising”, or any other non-exclusive terms are meant to state that processes, methods, articles, or systems including a series of elements will not only include those elements, other elements that haven't been explicitly listed or those elements inherent in such processes, methods, articles, or systems may also be included. In the absence of more restrictions, the element defined by the phrase “including/comprising a . . . ” will not preclude the existence of additional such elements in the processes, methods, articles, or systems that include the element.

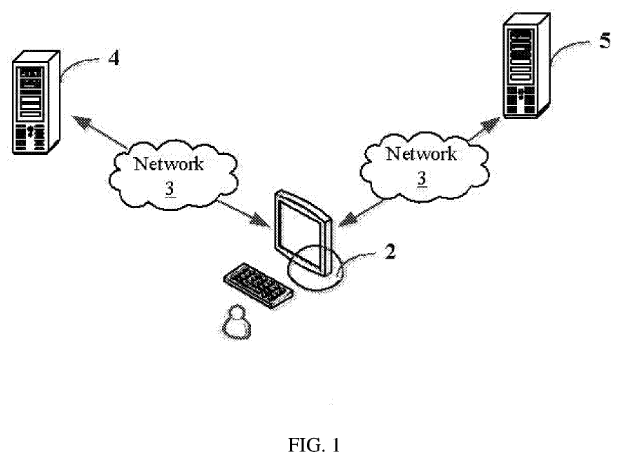

Referring to FIG. 1, it is a schematic diagram of an optional application environment for each embodiment of the present disclosure.

In an embodiment, the present disclosure may be applied to an application environment including, but not limited to, a server terminal 2, a network 3, a first application server 4, and a second application server 5. The server 2 can be rack-mounted servers, blade servers, tower or machine cabinet server computer device, the server terminal 2 can be an independent server or a cluster of servers. The network 3 may be a wireless or wired network including the Intranet, Internet, Global System of Mobile Communication (GSM), Wideband Code Division Multiple Access (WCDMA), 4G network, 5G network, Bluetooth, and WI-FI, etc.

The server terminal 2 is connected with the first application server 4 and the second application server 5 via the network 3 respectively. An application server terminal corresponding to the server terminal 2 (hereinafter referred to as “mobile terminal client”) is installed and runs on both the first application server 4 and the second application server 5. The application server is configured to create a persistent connection between the first application server 4, the second application server 5 and the server terminal 2 in response to a user operation of the server terminal 2, so that the first application server 4 and the second application server 5 are capable of transmitting data transmission and interacting with the server terminal 2 via the persistent connection.

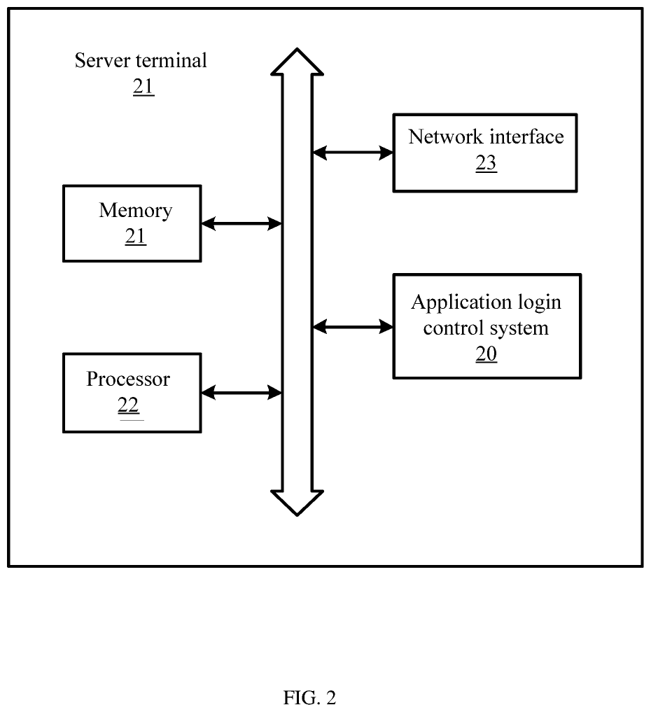

Referring to FIG. 2, it is a hardware configuration illustrating the server terminal 2 in FIG. 1 in accordance with an embodiment of the present disclosure. In an embodiment, the server terminal 2 may include, but not limited to, a memory 21, a processor 22, and a network interface 23 that can be connected with each other through a system bus. It is noted that, FIG. 2 only shows the server terminal 2 with components 21-23, but it should be understood that not all illustrated components may be implemented; and in other embodiments, more or fewer components may be implemented instead.

The memory 21 includes at least one type of readable storage medium including a flash memory, a hard disk, a multimedia card, a card type memory (e.g., SD or DX memory), and a random access memory (RAM), static random access memory (SRAM), a read only memory (ROM), an electrically-erasable programmable read only memory (EEPROM), a programmable read only memory (PROM), a magnetic memory, a magnetic disk, a computer disk, a CD, etc.

In some embodiments, the memory 21 could be an internal storage unit of the server terminal 2, such as a hard disk or a memory of the server terminal 2. In other embodiments, the memory 21 could also be an external storage device of the server terminal 2, such as a plug-in hard disk equipped on the server terminal 2, a smart media card (SMC), and a secure digital (SD) card, or a flash card. It is understood that the memory 21 could also include both the internal storage unit and external storage device of the server terminal 2. In an embodiment, the memory 21 is used to store an operation system and various types of application software installed in the server terminal 2, such as program codes of an application login control system 20. Further, the memory 21 could also be used to temporarily store various types of data that have been output or are to be output.

The processor 22 could be a central processing unit (CPU), a controller, a microcontroller, a microprocessor, or other data processing ships in some embodiments. The processor 22 is typically used to control the overall operation of the server terminal 2, for example, performing control or processing related to data interaction or communication with the server terminal 2. In this embodiment, the processor 22 is used to execute program codes stored in the memory 21 or data processing, such as running the application login control system 20.

The network interface 23 could include a wireless network interface or a wired network interface, which is generally used to establish a communication connection between the server terminal 2 and other electronic devices. In an embodiment, the network interface 23 is mainly used to connect the server terminal 2 with the first application server 4 and the second application server 5 via the network 3, and establish a data transmission channel and a communication connection between the server terminal 2 and the first application 4 and the second application server 5.

The application environment of various embodiments of the present disclosure, and the hardware configuration and functions of related devices have been described above in detail. The various embodiments of the present disclosure will be provided as follows according to the above application environment and related devices.

First, the present disclosure provides the application login control system 20.

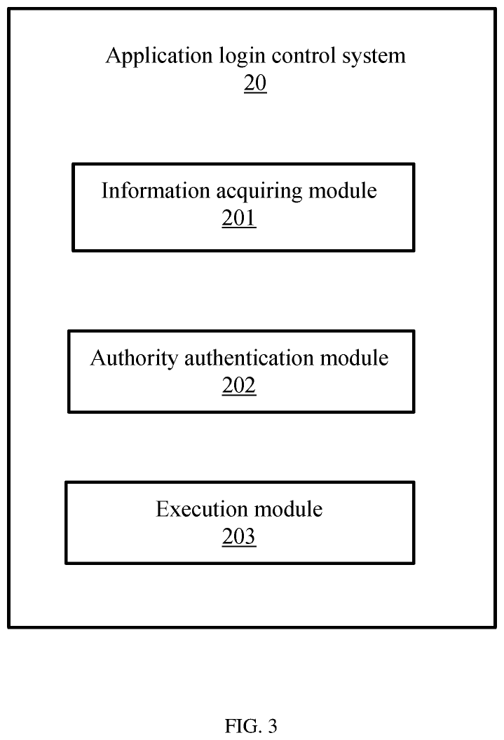

Referring to FIG. 3, it is a functional block diagram of the application login control system 20 in accordance with an embodiment of the present disclosure. In this embodiment, the application login control system 20 could be divided into one or more modules, and the one or more modules are being stored in the memory 21 and executed by one or more processors (this embodiment is executed by the processor 22) to complete this application.

For example, in FIG. 3, the application login control system 20 could be divided into an information acquiring module 201, an authority authentication module 202, and an execution module 203. The functional modules referred to in the present disclosure refer to a series of computer program instruction segments which could complete the certain function, which is more suitable than the program to describe the execution process of the application login control system 20 in the server terminal 2. The function modules 201-203 will be described in detail as follows respectively.

The information acquiring module 201 is used to acquire first authority control information of a user in a first application when the user logs in a portal system and accesses the first application in this portal system. In this embodiment, the portal system is installed in a server terminal (such as a portal server), and the user may be an administrator of the portal system. The user logins in the portal system and can further access the first application in the portal system by inputting a username and password.

In an embodiment, the first authority control information of the user in the first application includes, but not limited to, a first operation authority of the user in the first application, for example, the user can query and modify data in the first application.

In an embodiment, the first authority control information of the user in the first application is stored in the first application server 4 corresponding to the first application. When the user logs in the first application of the portal system, the first authority control information of the user in the first application is obtained from the first application server 4. In other embodiments, the first authority control information of the user in the first application can also be stored in the storage unit of the server terminal where the portal system is located.

The authority authentication module 202 is configured to, when the user switches from first application to a second application of the portal system, transfer a preset second authentication key between the portal system and the second application to the second application server 5 corresponding to the second application, and receive an operation authority authentication result of the user in the second application from the second application server 5 obtained according to the second authentication key transferred by the portal system.

In an embodiment, a first authentication key is preset between the portal system and the first application, the second authentication key is preset between the portal system and the second application, and the first authentication key is different from the second authentication key. That is, different authentication keys are preset between the portal system and different applications, and are stored in the portal system.

Further, the first application server 4 stores a backup of the first authentication key, and the second application server 5 stores a backup of the second authentication key. When a user switches from the first application to the second application of the portal system, the second authentication key is transferred to the second application server 5. According to the second authentication key transferred by the portal system, the second application server 5 authenticates the user's operation right in the second application. If the second authentication key transferred by the portal system is the same as the backup of the second authentication key stored in the second application server 5, it is determined that the operation authority authentication of the user in the second application is successful.

In an embodiment, when a user switches from the second application to the first application of the portal system, the first authentication key between portal system and the first application is transferred to the first application server 4 corresponding to the first application, and the first application sever authenticates the use's operation right in the first application according to the first authentication key transferred by the portal system. The first application sever authenticates the user's operation right in the first application according to the first authentication key transferred by the portal system. If the first authentication key transferred by the portal system is the same as the backup of the first authentication key stored in the first application server 4, it is determined that the operation authority authentication of the user in the first application is successful.

In other embodiments, the first authentication key can also be set to be the same as the second authentication key, that is, the portal system presets the same authentication key for different applications and the authentication key is stored in the portal system. Further, the first application and the second application may be preset in the same application server, and the portal system, the first application and the second application may be set in the same server (such as the server terminal).

The execution module 203 is configured, when the operation authority authentication of the user in the second application is successful, obtain the second authority control information of the user in the second application and perform corresponding operation of the user in the second application.

In an embodiment, the second authority control information of the user in the second application includes, but not limited to, a second operation authority of the user in the second application, for example, the user can query, modify and delete data in the second application. In this embodiment, the second authority control information of the user in the second application is different from the first authority control information of the user in the first application.

In an embodiment, the second authority control information of the user in the second application is stored in the second application server 5. When the user switches from the first application to the second application of the portal system, the portal system obtains the second authority control information in the second application from the second application server 5. In other embodiments, the second authority control information may also be stored in a storage unit of the server terminal where the portal system is located.

When the user switches from the first application to the second application with different operation authorities, the portal system authenticates automatically whether the user has the operation authority in the second operation. When the authentication is successful, the portal system obtains the second authority control information of the user in the second application and performs the corresponding operation of the user in the second application. The whole authentication process is completed automatically between the portal system and different applications, and user shielding by login control among applications of different operation authorities can be achieved, thus, the user does not need to log in the portal system multiple times, which is safe and convenient.

In the application login control system 20 of the present disclosure with the above modules 201-203, different authentication keys are preset between the portal system and different applications; when the user switches from the first application of the portal system to the second application of a different operation authority, the portal system authenticates automatically whether the user has the operation authority in the second application according to the preset authentication key; when the authentication is successful, the portal system obtains the second authority control information of the user in the second application and performs the corresponding operation of the user in the second application. The whole authentication process is completed automatically between the portal system and different applications, and user shielding by login control among applications of different operation authorities can be realized, thus, the user does not need to log in the portal system multiple times, which is safe and convenient.

In addition, the present disclosure further provides an application login control method.

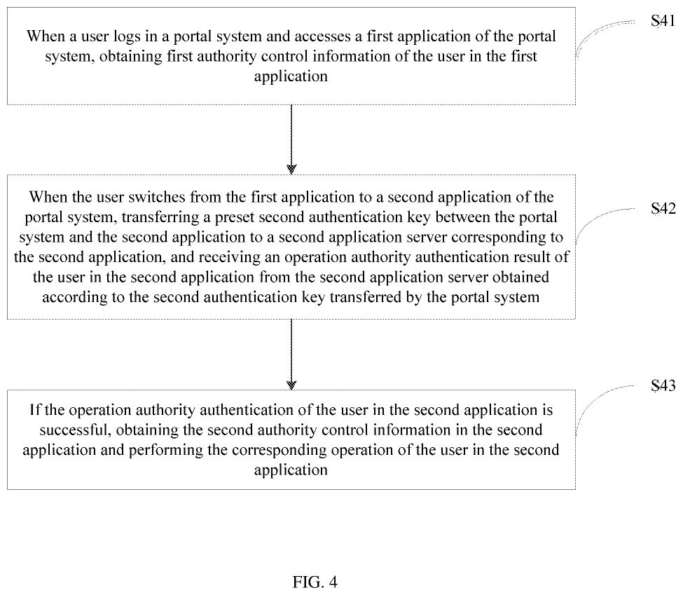

Referring to FIG. 4, it is a schematic flowchart of an implementation process of an application login control method. In the embodiment, the order of the steps in the flowchart shown in FIG. 4 could be changed according to different requirements, and some steps could be omitted as well.

Step S41, when a user logs in a portal system and accesses a first application of the portal system, obtaining first authority control information of the user in the first application. In this embodiment, the portal system is installed in a server terminal (such as a portal server), and the user could be an administrator of the portal system, and the user logs in the portal system and further access the first application by inputting a username and password.

In an embodiment, the first authority control information of the user in the first application includes, but not limited to a first operation authority of the user in the first application, for example, the user can query and modify the data in the first application.

In an embodiment, the first authority control information of the user in the first application is stored in a first application server 4 corresponding to the first application. When the user logs in the first application of the portal system, the portal system obtains the first authority control information of the user in the first application from the first application server 4. In other embodiments, the first authority control information of user in the first application can also be stored in a storage unit of the server terminal where the portal system is located.

Step S42, when the user switches from the first application to a second application of the portal system, transferring a preset second authentication key between the portal system and the second application to a second application server 5 corresponding to the second application, and receiving an operation authority authentication result of the user in the second application from the second application server 5 obtained according to the second authentication key transferred by the portal system.

In an embodiment, the first authentication key is preset between the portal system and the first application, the second authentication key is preset between the portal system and the second application, and the first authentication key is different from the second authentication key, that is, different authentication keys are preset between the portal system and different applications and are stored in the portal system. Further, the first application server 4 stores a backup of the first authentication key, and the second application server 5 stores a backup of the second authentication key. When the user switches from the first application to the second application of the portal system, the portal system transfers the second authentication key to the second application server 5, and the second application server 5 authenticates the operation authority of the user in the second application according to the second authentication key transferred by the portal system. If the second authentication key transferred by the portal system is the same as the backup of the second authentication key stored in the second application server 5, it is determined that the operation authority authentication of the user in the second application is successful.

In other embodiments, when the user switches from the second application to the first application of the portal system, the portal system transfers the first authentication key between the portal system and the first application to the first application server 4, and the first application server 4 authenticates the operation authority of the user in the first according to the first authentication key transferred by the portal system. If the first authentication key transferred by the portal system is the same as the backup of the first authentication key stored in the first application server 4, it is determined that the operation authority authentication of the user in the first application is successful.

In other embodiments, the first authentication key can also be set to be the same as the second authentication key, that is, the same authentication key is preset between the portal system and different applications and is stored in the portal system. Further, the first application and the second application may be preset in the same application server, and the portal system, the first application and the second application may be set in the same sever (such as a server terminal).

Step S43, if the operation authority authentication of the user in the second application is successful, obtaining the second authority control information in the second application and performing the corresponding operation of the user in the second application.

In an embodiment, the second authority control information of the user in the second application includes, but not limited to, a second operation authority of the user in the second application, for example, the user can query, modify and delete data in the second application. In this embodiment, the second authority control information of the user in the second application is different from the first authority control information of the user in the first application.

In an embodiment, the second authority control information of the user in the second application is stored in the second application server 5 corresponding to the second application. When the user switches from the first application to the second application of the portal system, the portal system obtains the second authority control information of the user in the second application from the second application server 5. In other embodiments, the second authority control information may also be stored in a storage unit of the server terminal where the portal system is located.

When a user switches from the first application to the second application with a different operation authority, the portal system authenticates automatically whether the user has the operation authority in the second operation; when the authentication is successful, the portal system obtains the second authority control information of user in the second application and performs the corresponding operation of the user in the second application. The whole authentication process is completed automatically between the portal system and different applications and user shielding by login control among applications of different operation authorities is achieved, thus, the user does not need to log in the portal system multiple times, which is safe and convenient.

Through the above steps S41-S43, the application login control method proposed by the present disclosure, by presetting the authentication key between the portal system and different applications, when a user switches from the first application of the portal system to the second application of a different operation authority, the portal system authenticates automatically whether the user has the operation authority in the second application according to the preset authentication key; when the authentication is successful, the portal system obtains the second authority control information of the user in the second application and performs the corresponding operation of the user in the second application. The whole authentication process is completed automatically between the portal system and different applications and user shielding by login control among applications with different operation authorities can be achieved, thus, the user does not need to log in multiple times, which is safe and convenient.

Further, in order to achieve the above object, the present disclosure further provides a computer-readable storage medium (such as a ROM/RAM, a computer disk, a CD), wherein the computer-readable storage medium stores an application login control system, and the application login control system can be executed by one or more processors to perform the steps of the application login control method.

Through the foregoing description of the embodiments, it is clear to persons skilled in the art that the present invention may be implemented by software plus necessary universal hardware, and definitely may also be implemented by hardware, but in many cases, the former implementation is preferred. Based on such an understanding, the technical solutions of the present invention essentially, or the part contributing to the prior art may be implemented in a form of a software product. The computer software product is stored in a readable storage medium, for example, a floppy disk, a hard disk, or an optical disc of the computer, and includes several instructions for instructing a computer device (which may be a personal computer, a server, or a network device or the like) to perform the methods described in the embodiments of the present invention.

The above preferred embodiments of the present disclosure are illustrated with reference to the accompanying drawings without intended to limit the scope of the application. The serial numbers of the embodiment of the present disclosure are merely for the description purpose, and should not be construed as limitations to the superiority or inferiority of the embodiments. In addition, although a logical order is shown in the flowcharts, in some cases the steps shown or described may be performed in a different order than the listed order.

The foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features thereof, as long as such modifications or replacements do not cause the essence of corresponding technical solutions to depart from the spirit and scope of the technical solutions of the embodiments of the present invention.

1. A server terminal, comprising a memory, a processor and an application login control system stored on the memory and running on the processor; the application login control system, when being executed by the processor, performing the following steps:
when a user logs in a portal system and accesses a first application of the portal system, obtaining first authority control information of the user in the first application;
when a user switches from the first application to a second application of the portal system, transferring a preset second authentication key between the portal system and the second application to a second application server corresponding to the second application, and receiving an operation authority authentication result of the user in the second application from the second application server obtained according to the second authentication key transferred by the portal system; and
If the operation authority authentication of the user in the second application is successful, obtaining second authority control information of the user in the second application, and performing the corresponding operation of the user in the second application.

2. The server terminal according to claim 1, wherein the portal system obtains the first authority control information of the user in the first application from the first application server corresponding to the first application, and obtains the second authority control information of the user in the second application from the second application sever corresponding to the second application, and the second authority control information of the user in the second application is different from the first authority control information of the user in the first application.

3. The server terminal according to claim 1, wherein a first authentication key is preset between the portal system and the first application, the second authentication key is preset between the portal system and the second application, and the first authentication key is different from the second authentication key.

4. The server terminal according to claim 1, wherein a backup of the second authentication key is stored in the second application server, if the second authentication key transferred by the portal system is the same as the backup of the second authentication key stored in the second application server, it is determined that the operation authority authentication of the user in the second application is successful.

5. The server terminal according to claim 2, wherein a backup of the second authentication key is stored in the second application server, if the second authentication key transferred by the portal system is the same as the backup of the second authentication key stored in the second application server, it is determined that the operation authority authentication of the user in the second application is successful.

6. The server terminal according to claim 3, wherein a backup of the second authentication key is stored in the second application server, if the second authentication key transferred by the portal system is the same as the backup of the second authentication key stored in the second application server, it is determined that the operation authority authentication of the user in the second application is successful.

7. The server terminal according to claim 4, wherein the application login control system performs the following steps when being executed by the processor:
when a user switches from the second application to the first application of the portal system, transferring, by the portal system, the first authentication key between the portal system and the first application to the first application server corresponding to the first application; and
if the first authentication key transferred by the portal system is the same as the back of the first authentication key stored in the first application, it is determined that the operation authority authentication of the user in the first application is successful.

8. An application login control method applied in a server terminal comprising:
when a user logs in a portal system and accesses a first application of the portal system, obtaining first authority control information of the user in the first application;
when the user switches from the first application to a second application of the portal system, transferring a preset second authentication key between the portal system and the second application to a second application server corresponding to the second application, and receiving an operation authority authentication result of the user in the second application server from the second application server obtained according to the second authentication key transferred by the portal system;
if the operation authority authentication of the user in the second application is successful, obtaining second authority control information of the user in the second application, and performing the corresponding operation of the user in the second application.

9. The method according to claim 8, wherein the portal system obtains the first authority control information of the user in the first application from a first application server corresponding to the first application, and obtains the second authority control information of the user in the second application from the second application sever corresponding to the second application, and the second authority control information in the second application of the user is different from the first authority control information in the first application of the user.

10. The method according to claim 8, wherein a first authentication key is preset between the portal system and the first application, the second authentication key is preset between the portal system and the second application, and the first authentication key is different from the second authentication key.

11. The method according to claim 8, wherein a backup of the second authentication key is stored in the second application server, if the second authentication key transferred by the portal system is the same as the backup of the second authentication key stored in the second application server, it is determined that the operation authority authentication of the user in the second application is successful.

12. The method according to claim 9, wherein a backup of the second authentication key is stored in the second application server, if the second authentication key transferred by the portal system is the same as the backup of the second authentication key stored in the second application server, it is determined that the operation authority authentication of the user in the second application is successful.

13. The method according to claim 10, wherein a backup of the second authentication key is stored in the second application server, if the second authentication key transferred by the portal system is the same as the backup of the second authentication key stored in the second application server, it is determined that the operation authority authentication of the user in the second application is successful.

14. The method according to claim 11, wherein the method further comprises the following steps:
when a user switches from the second application to the first application of the portal system, transferring the first authentication key between the portal system and the first application to the first application server corresponding to the first application; and
if the first authentication key transferred by the portal system is the same as the backup of the first authentication key stored in the first application server, it is determined the operation authority authentication of the user in the first application is successful.

15. A computer-readable storage medium with an application login control system stored thereon, which, when being executed by one or more processors, is capable of performing the following steps:
when a user logs in a portal system and accesses a first application of the portal system, obtaining first authority control information of the user in the first application;
when a user switches from the first application to a second application of portal system, transferring a preset second authentication key between the portal system and the second application to a second application server corresponding to the second application, and receiving an operation authority authentication result of the user in the second application from the second application server obtained according to the second authentication key transferred by the portal system; and if the user is authenticated with operation authority of the second application, obtaining the second authority control information of the user in the second application and performing the corresponding operation of the user in the second application.

16. The computer-readable storage medium according to claim 15, wherein the portal system obtains the first authority control information of this user in the first application from the first application server corresponding to the first application, and obtains the second authority control information of this user in the second application from the second application server corresponding to the second application, and the second authority control information of the user in the second application is different from the first authority control information of the user in the first application.

17. The computer-readable storage medium according to claim 15, wherein a first authentication key is preset between the portal system and the first application, and the second authentication key is preset between the portal system and the second application, and the first authentication key is different from the second authentication key.

18. The computer-readable storage medium according to claim 15, wherein a backup of the second authentication key is stored in the second application server, if the second authentication key transferred by the portal system is the same as the backup of the second authentication key stored in the second application server, it is determined that the operation authority authentication of the user in the second application is successful.

19. The computer-readable storage medium according to claim 16, wherein a backup of the second authentication key is stored in the second application server, if the second authentication key transferred by the portal system is the same as the backup of the second authentication key stored in the second application server, it is determined that the operation authority authentication of the user in the second application is successful.

20. The computer-readable storage medium according to claim 19, wherein the application login control system performs the following steps when being executed by the processor:
when a user switches from the second application to the first application of portal system, transferring the first authentication key between the portal system and the first application to the first application server corresponding to the first application; and if the first authentication key transferred by the portal system is the same as the backup of the first authentication key stored in the first application server, it is determined that the operation authority authentication of the user in the first application is successful.
